(19) United States
(12) Patent Application Publication
(10) Pub. No.: US 2006/0123709 A1
(43) Pub. Date: Jun. 15, 2006

(54) Abrasive enhancing composition

(76) Inventor: Ricky Lee Vaal, Sarasota, FL (US)

Correspondence Address: DOROTHY S. MORSE, ESQ, 515 PARK DRIVE, NW, BRADENTON, FL, 34209-1847, US

(21) Appl. No.: 11/012,743

(22) Filed: Dec. 15, 2004

(51) Int. Cl. B03B 7/00; C09G 1/02; C09K 3/14

(52) U.S. Cl. 51/307; 209/13; 106/3; 51/308; 51/309

(57) ABSTRACT

An abrasive enhancing composition that contains water, a polymeric thickening ingredient, and neutralizing agent, as well as a method for its manufacture. Additionally, the composition can also include color, fragrances, lubricants, preservatives, and/or bactericides. It is incorporated into sanding applications to extend the life of the abrasive materials used and diminish operating costs. It also prevents uneven sanding marks and decreases buff out time. In addition, since the composition readily adheres to surfaces intended for sanding and does not easily run off of them and onto the floor, its use promotes a cleaner and safer work environment. It is contemplated for wet and dry sanding operations.

### CROSS-REFERENCES TO RELATED APPLICATIONS

The applicant herein mailed a Document Disclosure Deposit Request on Oct. 4, 2004 to the U.S. Patent & Trademark Office, with accompanying papers that disclosed an invention having substantially the same subject matter as the invention disclosed herein, and which was entitled “Abrasive Enhancing Gel”. The Document Disclosure Deposit Request was given a reference number of 562469 on Oct. 14, 2004. All benefit provided by the Document Disclosure is herein requested.

### BACKGROUND OF THE INVENTION—FIELD OF THE INVENTION

This invention relates to the field of sanding operations using abrasives, such as but not limited to the machine and hand sanding operations conducted with sandpaper during the preparation of a surface for primer, painting, polishing, or during spot repair of a painted or clearcoated finish, and more specifically to a composition that when used during sanding operations will provide a variety of benefits, including extending the life of sandpapers of any size or grit, adding lubrication, and producing more uniformity in a finished sanded surface by reducing the number, size and depth of sanding craters. The present invention composition also produces fewer deep scratches while at the same time avoiding the creation of “fish eyes” in painted surfaces. In addition, the present invention provides cost savings, temperature reduction, and less buffing and polishing time to regain the desired finish in terms of smoothness and gloss.

### BACKGROUND OF THE INVENTION—DESCRIPTION OF THE RELATED ART

Traditionally, the process of wet sanding surfaces, such as painted surfaces, surfaces covered with Clearcoat and other protective polymer compositions, non-painted surface, fiberglass, gel-coated surfaces, stainless steel, aluminum, glass, granite, marble, stone, plastics, ceramics, wood, Plexiglass and other glass substitutes, chrome, reflective surfaces, natural gemstones, manmade gemstones, fiberglass, carbon fiber, Kevlar and other resinous materials used for reinforcement, Lexan and other synthetic resinous composites, brass, silver, and gold, has required the use of water, which creates many disadvantages. Due to the running characteristics of water, work areas where wet sanding is performed tend to be messy and inherently dangerous to the operator. Water also gets on the operator. In addition, during the wet sanding process, water does not remain evenly distributed across the surface being sanded, and results in uneven sanding marks. The running characteristics of water further prevent it from significantly reducing the friction between a sanded surface and the abrasives used for sanding it, resulting in the sandpapers and other abrasives used with water becoming quickly spent. Further, water shortens the life of the sandpapers used in the wet sanding process when the adhesive section of their backings becomes excessively saturated with water, which causes premature adhesive failure and separation of the sanding element from its carrier backing. Another potential problem in any sanding process is the heat generated by friction when the abrasive material comes into contact with the surface to be sanded. The increase in surface temperature so generated softens painted and clear-coated surfaces, and can result in the creation of deep scratches. The present invention composition replaces the use of water, and thereby eliminates messy and dangerous work areas. During use of the present invention composition, water saturation of adhesive sandpaper backings is greatly decreased, and the life of sandpaper employed with it to complete sanding operations is extended, providing cost savings. Further, testing has demonstrated that the present invention composition decreases the temperature of a surface during the sanding process by as much as 8%, while increasing the adhesive life of sandpaper backing so that the life of sandpapers used with the present invention composition is extended as much as six times. In addition, the present invention composition has lubricating characteristics, eliminates water run off onto floor surfaces in and around a work area, prevents uneven sanding marks, and decreases buff out time. Further, it has been subjected to independent “fish eye” testing, proving that the present invention composition does not create or promote the formation of small holes in painted or clearcoated surfaces that extend all the way back to underlying primer. There is no sanding composition known that has the same features and components as the present invention, nor all of its advantages.

### BRIEF SUMMARY OF THE INVENTION—OBJECTIVES AND ADVANTAGES

The primary object of this invention is to provide a composition for use in wet sanding operations in place of water that reduces the number, size, and depth of sanding craters in a finished surface so as to gain the required appearance in terms of surface smoothness and gloss in less time and without multiple polishing steps. A further object of this invention to provide a composition for wet sanding operations that increases the life of abrasive materials to decrease operating costs. It is also an object of this invention to provide a composition for wet sanding operations that is non-toxic, non-flammable, and requires no special storage or handling requirements. It is a further object of this invention to provide a composition for wet sanding operations that is simple to manufacture, has an extended shelf life, and is easy to apply. It is also an object of this invention to provide a composition for wet sanding operations that can be repeatedly frozen and thawed without deterioration for shipping, storage, and use in colder climates. It is a further object of this invention to provide a composition that is cost effective to make and use.

The present invention is a water-based and user-friendly composition that is employed with abrasives while they are being used in sanding operations to prolong their useful life as much as six times. It has a neutral pH and a thickened consistency that provides excellent lubrication and promotes uniform sanding characteristics when used with any grit or size of wet or dry sandpaper. Thus, when the present invention composition is used, irrespective of the abrasive material employed, the number, size, and depth of sanding craters are reduced. The present invention can be sprayed onto a surface prior to sanding, or applied in a droplet form. Since it has a thickened consistency, it remains in place after application, ready for the sanding operation to begin. As testing has revealed, the present invention decreases the temperature of the surface being sanded as much as 8%, and it does not create “fish eyes” when surface is painted. Since the ingredients to make the present invention composition are all commercially available and in ready supply, and frequently only one drop of the present invention composition is needed for a spot sanding operation, it is cost effective to make and use.

While the description herein provides preferred embodiments of the present invention composition, it should not be used to limit its scope. For example, variations of the present invention, while not shown and described herein, can also be considered within the scope of the present invention, such as but not limited to variations in the mixing speeds and times used; the number and type of additives used with the composition, such as but not limited to fragrances, colorants, and preservatives; the size and type of mixing vessel used; the pH used in the finished composition; and the type of water used to prepare the composition. Thus, the scope of the present invention should be determined by the appended claims and their legal equivalents, rather than being limited to the examples given.

### BRIEF DESCRIPTION OF THE SEVERAL VIEWS OF THE DRAWINGS

No illustrations have been provided in support of the Detailed Description below, since the invention disclosed herein is a composition and a method for its manufacture.

### DETAILED DESCRIPTION OF THE INVENTION

The composition according to the most preferred embodiment of the present invention is applicable in wet sanding operations of painted surfaces, surfaces covered with Clearcoat and other protective polymer compositions, non-painted surfaces, aluminum, stainless steel, gel-coated surfaces, glass, granite, marble, stone, plastics, ceramics, wood, Plexiglass and other glass substitutes, chrome, reflective surfaces, natural gemstones, manmade gemstones, fiberglass, carbon fiber, Kevlar and other resinous materials used for reinforcement, Lexan and other synthetic resinous composites, brass, silver, and gold, and provides a better result, in less time and with less mess, and for a lower cost, than when water alone is used with wet sanding abrasives. It is obtained by adding an amount of water to a mixing vessel that will be responsible for between approximately 90% and 98% by liquid volume of the finished composition. The water can be distilled, de-ionized, tap, spring, or deep-well water, or a combination thereof, whereas the mixing vessel is preferably plastic, stainless steel, or aluminum, and is equipped with a high sheer mixer. While mixing of the present invention composition can be successfully accomplished while subject to a wide range of ambient temperatures, such as temperatures between approximately 45° and 110° Fahrenheit, the most preferred range of ambient temperatures for mixing the present invention composition is approximately 70° to 85° Fahrenheit. Once the selected amount of water is in the mixing vessel, the high sheer mixer is activated and set to approximately 1200 rpm, which creates a vortex in the water's surface. With the high sheer mixer continuing to maintain the vortex, a thickening ingredient is slowly sifted into the water through a sleeve or mesh screen positioned over the vortex. More than one thickening ingredient or type of thickening ingredients can be used. Mixing continues until the particles of the thickening ingredient or ingredients swell, become invisible, and completely hydrate, which typically occurs in approximately fifteen minutes. At this time, the mixture has a pH of approximately three, which will not allow it to thicken. Once a neutralizing agent is slowly added to the vortex, and a pH of at least five is achieved with continued mixing at the previously maintained speed of approximately 1200 rpm for an additional time period of approximately ten minutes, the composition of the most preferred embodiment of the present invention will thicken. Additional ingredients can be thereafter added to the present composition, including but not limited to colorants, fragrances, lubricants, preservatives, and/or bactericides, as needed by an intended application.

It is contemplated for the thickening ingredients added to the present invention composition to be in liquid or powder form. However, in the present invention a powder is preferred over a liquid. When a powder is used, it is contemplated for it to range between approximately 0.005% to 5% of the composition by weight, however, a powder weight of approximately 1% to 2% is preferred. When thickening ingredients in powder form are used, similar concentration percentages relative to the entire composition are contemplated, but as determined by percent weight instead of percent volume. Further, although not limited thereto, the thickening ingredients used in the present invention can include polymers, such as but not limited to acrylic polymers, polymeric emulsifier, acrylic co-polymers, and high performance and/or dispersible polymers, which are well-known and commercially available from several companies, including Noveon, Inc. under the trade names of CARBOPOL® 941 Polymer, CARBOPOL® AQUA 30, NOVERMER® EC-1, PEMULEN® 1622, CARBOPOL® 676D, CARBOPOL® EZ3, and CARBOPOL® ETD 2691. Other desirable thickening ingredients, to be used in varying combinations with one or more of the polymer thickening ingredients or alone, can include, but are not limited to, dispersible xanthan gum purchased from Kelco under the trade name of KELZAN ST® or KELCOGEL®, hydroxyethylcellulose purchased from Hercules under the trade name of NATROSOL®, and clays purchased from Rockwood Specialties, Inc. under the trade name of LAPONITE®. Several neutralizing agents effectively employed as a part of the present invention composition, include sodium hydroxide, caustic soda liquid, caustic soda ash, amino alcohol, 2-amino-2-methyl-1-propanol, 2-methylamino-2-methyl-1-propanol, morpholine, and/or triethanolamine. However, the neutralizing agents used in the present invention composition are not limited to such neutralizing agents and may include many other pH adjusting agents and/or ingredients. Neutralizing agent is only added to the present invention composition after the thickening ingredient has been hydrated. The neutralizing agent concentration can vary between approximately 0.005% and 5% of the total composition volume, but is preferably between 0.005% and 1% of the total composition volume. As long as the pH of the mixed composition is raised to at least five, it will thicken. However, a pH range of between five and eleven can be used, with a user-friendly pH range of six to eight being preferred. The individual neutralizing agents mentioned above are usually selected for use in the most preferred embodiments of the present invention composition, as their properties are well-known and they are commercially available.

Colorants and/or fragrances can be added to the present invention composition in liquid or powder form. Also, lubricants used with the present invention composition can include but are not limited to mineral oils, paraffin oils, fluid silicone oils, silicone resins, amino-functional silicones, fluorinated silanes, fluorated oils, bee's wax, carnauba wax, and lanolin. However, when a surface sanded with the present invention composition is to be painted, the addition of lubricants is not recommended to avoid potential problems with paint bonding and/or the formation of “fish eyes”. As previously stated, independent testing has confirmed that when the present invention composition does not contain lubricants and is used on painted surfaces with sanding abrasives, the present invention composition does not promote or create the formation of “fish eyes”. While the shelf life of the present invention composition is at least one year, preservatives and/or bactericides can be used in combination with fragrances, coloring, and lubricants, as needed, to increase composition's shelf life beyond one-year and/or adapt the present invention composition to differing applications. Further, the present invention composition can be repeatedly frozen and thawed without adverse effect, which facilitates its shipping, storage, and use in colder climates.

Using a present invention composition having 90% to 98% water, 0.005% to 5% thickening ingredient, and 0.005% to 5% neutralizing agent, several tests were conducted to evaluate its effectiveness in sanding applications conducted under different conditions, with the following results. Machine sanding applications were first conducted, followed by hand sanding applications. The first test involved the use of a one-and-three-eighths inch diameter 2500 grit psa sanding disc, a model 57502 Dynabrade air sander, a black painted and clear coated test panel, and tap water. After five sanding applications, the sanding disc would no longer perform at the desired level, a temperature of ninety-one degrees Fahrenheit was reached during all five applications, and the water used during the sanding application ran onto the floor around the test panel causing the floor's surface to become slippery. After sanding, the test surface was polished using a model 56015 Dynabrade polisher equipped with a three-inch foam pad and a liquid polishing compound. After an initial buffing period, several deep scratches were still present, which required a second polishing application to completely remove them and gain the desired test surface appearance in terms of surface smoothness and gloss. In contrast, when the present invention composition was substituted for the water, only one drop of inventive composition was required for each application. All of the other testing parameters remained the same. When five sanding applications had been finished using the present invention composition, the point at which the sanding disc used with tap water would no longer perform at the desired level, the sanding disc still had usable life. A total of thirty sanding applications were accomplished before the sanding disc used with the present invention composition would no longer perform at the desired level. Also, use of the present invention composition resulted in a more uniform finish with sanding craters being reduced in number, depth, and size, and most deep scratches were eliminated without multiple polishing steps, and further, the present invention required less clean up time, provided lubrication during the sanding process which assisted in providing a temperature drop in the sanded surface of as much as 8%, and the messy and potentially dangerous accumulation of water on the floor around the test panel was eliminated. Further, the present invention composition typically required only one polishing application to remove sand marks/craters to gain the required appearance in terms of smoothness and gloss.

After machine-sanding tests were concluded, testing of the present invention composition was conducted in hand-sanding applications on the painted and clear-coated surface of an automobile. The first test involved the use of a backing pad, plain tap water in a spray bottle, and 1500 grit wet/dry sand paper. It was noted that the water ran off of the automobile surface very quickly and did not provide adequate lubrication. Further, a significant amount of water was required to gain the needed sanding results, and a substantial amount of water used eventually accumulated on the floor causing unsafe working conditions for the operator. In addition, a substantial amount of water ended up on the operator as well. Uneven patterns were created in the test surface and several sanding applications were needed to accomplish the desired appearance. Polishing was next accomplished using a model 56015 Dynabrade polisher equipped with a six-inch foam polishing pad and a liquid polishing compound. Several deep scratches were still present after the first polishing application, and a second polishing application was needed to completely remove all deep scratches and gain the required appearance in terms of surface smoothness and gloss. In contrast, when the present invention composition was substituted for the water, the inventive compound was placed in the spray bottle and a light mist was sprayed on the area to be sanded. Use of the present invention composition resulted in a safer work area because there was no water run-off onto the floor, a more uniform surface finish was also achieved with sanding craters being reduced in number, depth, and size, the present invention composition extended the life of the sandpaper used so that it was able to be employed in four additional sanding applications beyond that which sandpaper used with water could achieve, the amount of deep scratches was decreased over the sanding operation in which water was used in place of the present invention composition, and only one polishing application was needed with the present invention composition to gain the required appearance in terms of smoothness and gloss.

1. A composition for improving sanding operations of painted surfaces, surfaces covered with protective polymers, non-painted surfaces, aluminum, stainless steel, gel-coated surfaces, glass, granite, marble, stone, plastics, ceramics, wood, glass substitutes, chrome, reflective surfaces, natural gemstones, manmade gemstones, fiberglass, carbon fiber, resinous materials used for reinforcement, synthetic resinous composites, brass, silver, and gold, said composition comprising:
water;
at least one thickening ingredient representing approximately 0.005% to approximately 5% of said composition; and
an amount of neutralizing agent required to raise the pH of said composition above a pH of approximately 5 but no higher than a pH of approximately 11 so that said composition will sufficiently thicken for use in wet sanding operations for a better result in terms of surface smoothness and gloss, with reduced sanding time, extended life of abrasives used, less mess, and reduced operating cost when compared to wet sanding operations involving water alone.

2. The composition of claim 1 wherein said at least one thickening ingredient comprises an acrylic polymer.

3. The composition of claim 1 wherein said water comprises approximately 90% to approximately 98% by volume of said composition.

4. The composition of claim 1 wherein said at least one neutralizing ingredient comprises approximately 0.005% to approximately 5% by volume of said composition.

5. The composition of claim 2 wherein said at least one acrylic polymer comprises approximately 0.005% to approximately 5% by volume of said composition.

6. The composition of claim 5 wherein said water comprises approximately 90% to approximately 98% by volume of said composition.

7. The composition of claim 6 having a pH ranging between approximately 6 and approximately 8.

8. The composition of claim 1 further comprising additional ingredients selected from a group consisting of colorants, fragrances, preservatives, bactericides, and lubricants.

9. The composition of claim 3 further comprising additional ingredients selected from a group consisting of colorants, fragrances, preservatives, bactericides, and lubricants.

10. The composition of claim 4 further comprising additional ingredients selected from a group consisting of colorants, fragances, preservatives, bactericides, and lubricants.

11. The composition of claim 2 wherein said at least one acrylic polymer is selected from a group consisting of acrylic polymers in liquid form and acrylic polymers in powder form.

12. A method for making a composition for improving sanding operations of painted surfaces, surfaces covered with protective polymers, non-painted surfaces, glass, granite, marble, stone, plastics, ceramics, wood, glass substitutes, chrome, reflective surfaces, natural gemstones, manmade gemstones, aluminum, stainless steel, gel-coated surfaces, fiberglass, carbon fiber, resinous materials used for reinforcement, synthetic resinous composites, brass, silver, and gold, to extend the life of abrasive materials, whereby use of said composition saves on operating costs and extends the life of abrasives used therewith, said method comprising the steps of:
providing a mixing vessel with a high sheer mixer, at least one thickening ingredient, at least one neutralizing ingredient, and water;
placing a desired amount of said water into said mixing vessel;
activating said high sheer mixer so as to cause a vortex in said water;
slowly sifting said at least one thickening ingredient into said water to create a mixture;
continuing to maintain said vortex in said mixture of said water and said at least one thickening ingredient;
adding an amount of said neutralizing ingredient sufficient to raise the pH of said mixture of said water and said at least one thickening ingredient above a pH of approximately 5;
continuing to maintain said vortex in said mixture of said water and said at least one thickening ingredient until said at least one thickening ingredient is fully hydrated and said mixture of said water and said at least one thickening ingredient becomes thickened.

13. The method of claim 12 wherein said mixture comprises approximately 0.005% to approximately 5% by volume of said at least one thickening ingredient.

14. The method of claim 12 wherein said mixture comprises approximately 90% to approximately 98% by volume of said water.

15. The method of claim 12 wherein said mixture comprises approximately 0.005% to approximately 5% by volume of said at least one neutralizing ingredient.

16. The method of claim 12 further comprising a step of providing additional ingredients selected from a group consisting of colorants, fragrances, preservatives, bactericides, and lubricants, and a step of adding selected ones of said additional ingredients to said mixture.

17. The method of claim 12 wherein said at least one thickening ingredient comprises at least one acrylic polymer selected from a group consisting of acrylic polymers in liquid form and acrylic polymers in powder form.

18. The method of claim 12 wherein said step of adding an amount of said neutralizing ingredient sufficient to raise the pH of said mixture of said water and said at least one acrylic polymer above a pH of approximately 5 further comprises adding sufficient neutralizing agent to raise said pH of said mixture between approximately 5 and approximately 11.

19. The method of claim 12 wherein said mixing vessel is selected from a group consisting of plastic vessels, stainless steel vessels, and aluminum vessels.

20. The method of claim 12 wherein said steps of slowly sifting said at least one thickening ingredient into said water to create a mixture, adding an amount of said neutralizing ingredient sufficient to raise the pH of said mixture, and continuing to maintain said vortex in said mixture occur when ambient temperatures are above approximately 45° and below approximately 110° Fahrenheit.
